(19) United States
(12) Patent Application Publication
(10) Pub. No.: US 2007/0170676 A1
(43) Pub. Date: Jul. 26, 2007

(54) Dolly, and transportation using same

(76) Inventor: Rodney Arthur Hilditch, West Midlands (GB)

Correspondence Address: GREENLEE WINNER AND SULLIVAN P C, 4875 PEARL EAST CIRCLE, SUITE 200, BOULDER, CO, 80301, US

(21) Appl. No.: 10/598,532

(22) PCT Filed: Mar. 3, 2005
(86) PCT No.: PCT/GB05/00826

§ 371 Date: Nov. 29, 2006

(30) Foreign Application Priority Data
Mar. 3, 2004 (GB) 0404694.2

(51) Int. Cl. B62B 1/00

(52) U.S. Cl. 280/79.11

(57) ABSTRACT

A dolly on which a materials handling package such as a crate or pallet can be carried has wheels (15, 16, 17, 18) each having a peripheral surface comprising a plurality of spaced projections and recesses therebetween, facilitating running of the dolly over a support surface of corrugated form such as may be found on a railway wagon for motor vehicle transportation. This facilitates the use of such railway wagons for transportation of vehicle components on the return journey after having delivered vehicles.

This invention relates to a dolly, i.e. a device in the general form of a small platform having a surface on which a load such as a materials handling package can be placed, and having wheels facilitating its movement over a surface. The invention also relates to a method of transportation using dollies in accordance with the invention.

Dollies on which materials handling packages such as crates or pallets can be placed to facilitate their movement over a floor surface, into and out of vehicles, and so forth, are well known. A dolly is usually generally rectangular in plan view, having four wheels of which one pair adjacent one end of the dolly are rotatable about a fixed axis or axes extending transversely of the dolly while the pair of wheels adjacent the other end may be castor wheels able to pivot to enable the dolly to be steered while it is being moved on its wheels.

The invention has been devised to facilitate the use of dollies to load materials handling packages on to railway wagons of the kind generally used to transport motor vehicles such as cars, to carry the packages on the wagons while the wagons are moved by rail, and then to unload the packages from the wagons and facilitate movement of the packages to where they are required to be stored or unloaded at their destination.

Railway wagons for motor vehicle transportation, e.g. for carriage of cars and commercial vehicles from factories where they are assembled to distribution centres which may be far distant, have a deck surface on which the vehicles are driven, and the most common type of deck surface, of which some thousands of wagons are in use in Europe, is of corrugated form comprising ridges extending transversely of the wagon and spaced from one another lengthwise of the wagon by troughs or recesses. The ridges and troughs therebetween are both, in cross-sectional view, of generally rectangular form. Having been driven onto the wagon, a vehicle is parked in the required position with parking brake brake applied, and in gear, with chocks applied to its wheels to prevent it from moving when the wagon is travelling.

After having been used to transport assembled vehicles from the factory, rail wagons for this purpose usually are conveyed back to the factory empty for further use. This is inefficient. Vehicle factories, of course, have delivered to them large numbers of components for vehicle assembly, and it would be desirable if the wagons used for transporting assembled vehicles from the factory could be used to transport components back to the factory, not necessarily from the point at which the vehicles are unloaded but from some other point which could involve the wagons in a shorter journey while empty. However, the loading of components on the wagons presents problems.

Components may be carried in materials handling packages capable of being fitted on dollies to be loaded on the wagons, transported while on the dollies, and unloaded thereon, but conventional dollies are not well adapted to be carried in conventional wagons as described above. As a dolly is essentially a low-height device, the wheels of the dolly usually are of small diameter and will not run satisfactorily over the corrugated deck of a wagon: the shaking which would be caused to the dolly and a package carried thereby could even be sufficient to shake a load loose from the dolly or cause damage to the components. Accordingly it is one object of the present invention to provide a dolly which is more suitable for use in this manner with vehicle-transporting railway wagons.

It will, of course, be appreciated that a dolly in accordance with the invention is usable in other situations where like requirements arise, and for road and other vehicles as well as railway wagons.

According to one aspect of the invention, we provide a dolly on which a load such as a materials handling package can be carried and having wheels enabling its movement over a support surface, wherein the wheels each have a peripheral surface which comprises a plurality of spaced projections with recesses therebetween. Appropriately dimensioned, this enables relatively smooth running on a corrugated support surface with the projections entering troughs between ridges of the support surface.

The projections on the wheel surface may, viewed parallel to the rotational axis of the wheel, and the recesses therebetween, be somewhat rectangular in form, albeit with the sides of each projection or recess converging towards its root (necessitated by the circumferential disposition of the projections) and the projections and recesses having rounded corners.

Such a wheel surface will run satisfactorily over a corrugated support surface in which the corrugations are of generally rectangular form, as described above and commonly used in wagons for motor vehicle transportation. When running transverse to the length of the corrugations, the projections on the wheels enter the troughs between the ridges of the corrugations while the ridges enter the recesses between the projections on the wheels. The wheels may thus run smoothly over the corrugated support surface, without the problem above described when a relatively small diameter circular wheel runs over such a surface.

An example of appropriate dimensions for a wheel suitable for running over a corrugated support surface of the type and dimensions commonly found on railway wagons for vehicle transportation is given hereafter. It will, of course, be appreciated that the dimensions may be different if the wheels are required to run over a support surface of different dimensions.

The width of each wheel should be greater than the spacing between the ridges of the corrugated support surface. This means that if a pivotable castor wheel of the dolly, instead of running transversely to the direction of the corrugations turns so as to lie parallel to the direction of the corrugations, i.e. with its rotational axis transverse to the direction of the corrugations, the wheel cannot become trapped in the trough between adjacent corrugations.

Preferably the wheel is of a rubber and/or polymeric material selected so as to give it the required strength with a degree of resiliency enabling it to roll quietly and easily over a variety of surfaces including plain ground surfaces over which a dolly may be required to be moved prior to loading onto and after unloading from a wagon. The particular form of wheel described will, despite its non-circular profile, run satisfactorily smoothly on a plain ground surface and, compared with a small diameter circular wheel, surmount small obstacles and steps (e.g. a cable on a warehouse or factory floor) more easily.

A wheel of the construction described may run directly on an axle without the need for an intermediate bearing assembly, this being acceptable for low speeds and small distances over which a dolly is likely to have to be moved.

The wheels may be rigidly supported by the dolly (although two of them may be pivotable castor wheels) or may be supported by a suspension means allowing them to move upwardly and downwardly relative to the dolly. They may be able to retract relative to the dolly, to facilitate storage of a number of dollies stacked one upon the other.

The dolly may comprise a body part which is of a plastics material, e.g. rotationally moulded, affording a load-carrying surface on which a materials handling package can be carried. The wheels may be partially accommodated in recesses formed in the platform, so that part only of the periphery of each wheel extends out of the recesses beneath the platform. The load-carrying surface of the body part may be corrugated or otherwise configured to assist in secure location of a materials handling package thereon, and provided with lugs, recesses, and any other features appropriate for the purpose. The wheels may be carried by a chassis assembly to which the body part is secured.

The dolly may be provided with coupling means of any appropriate form, enabling a number of dollies to be connected together and handled as a “train” which can be towed.

The dolly may be provided with means for accommodating an identification device, e.g. a radio transponder, enabling its whereabouts to be identified and its movements to be tracked.

A dolly in accordance with the invention is particularly suitable for use in carrying materials handling packages containing, e.g. motor vehicle components, on railway wagons for motor vehicle transportation. In this use of the dollies, a number thereof would be connected to one another by their coupling means to form a train, either before or after materials handling packages have been placed on the dollies. The train would then be loaded on an appropriate number of the vehicle transportation wagons, being towed onto the wagons from one end of the railway train by a suitable towing vehicle (it will be appreciated that vehicles such as cars are loaded onto a railway train by being driven forwardly from one end of the train and from wagon to wagon by appropriate interconnecting support surfaces, the vehicles being unloaded at their destination by being driven forwardly off the train of wagons from the end opposite to that at which they were loaded). The train of dollies would be split into portions suitable for each individual wagon, and secured in each wagon by appropriate restraining straps at the front and rear of the part-train of dollies on that wagon.

It will be noted in this that the configuration of wheel described hereafter interfits with the corrugated load surface of a wagon in such a way as to provide a self-chocking effect to some extent, resisting movement of the dollies in addition to the restraint thereof by restraining straps.

At the destination of the loaded dollies, they would be reassembled into a train of dollies and towed off the wagons to be taken to where they are required, e.g. a warehouse or factory.

After having been unloaded of their materials handling packages, empty dollies could be returned to their source or some other point by any appropriate means. A large number of dollies, stacked and otherwise arranged as necessary, could be carried on a single railway wagon.

According to another aspect of the invention, we provide a method of transporting goods, comprising loading the goods on a dolly according to the first aspect of the invention, and carrying the dolly on a vehicle which preferably is a railway wagon for motor vehicles, e.g. cars, transportation.

The method may comprise connecting a plurality of dollies together to form a train thereof, and loading the train of dollies onto at least one of the wagons.

The train of dollies may be secured in position on the wagon by securing means, e.g. fastening straps, connecting the foremost and rearmost dollies on the wagon to the structure of the wagon. If the length of the train of dollies is such that it occupies more than a single wagon, it may be broken down into portions each comprising an appropriate number of dollies for each wagon.

When secured in position on wagons in such a manner, the configuration of the wheels is such that it interfits with the corrugated wagon load surface, to provide a self-chocking effect in the manner described hereafter.

The invention will now be described by way of example with reference to the accompanying drawings, of which:

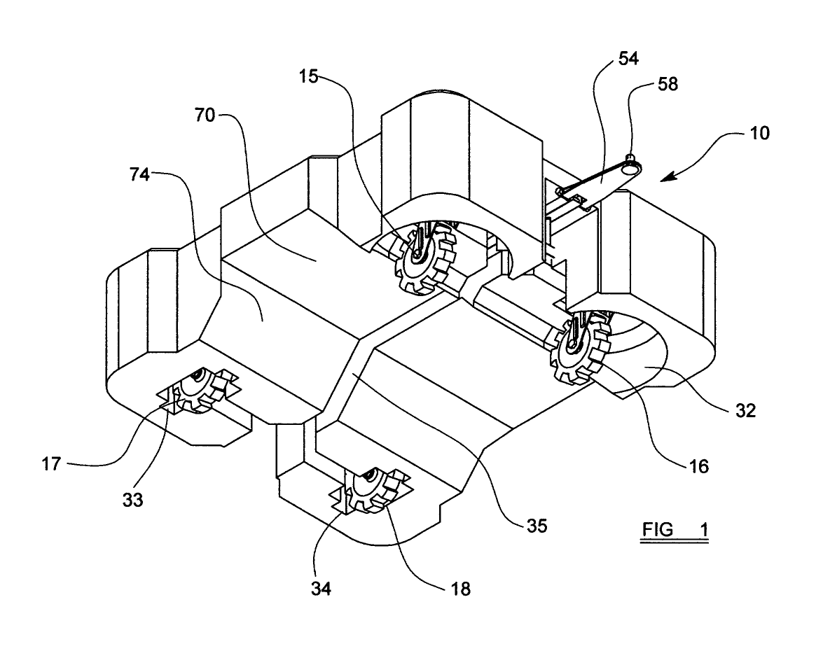

FIG. 1 is a view of the underside of a dolly in accordance with the invention.

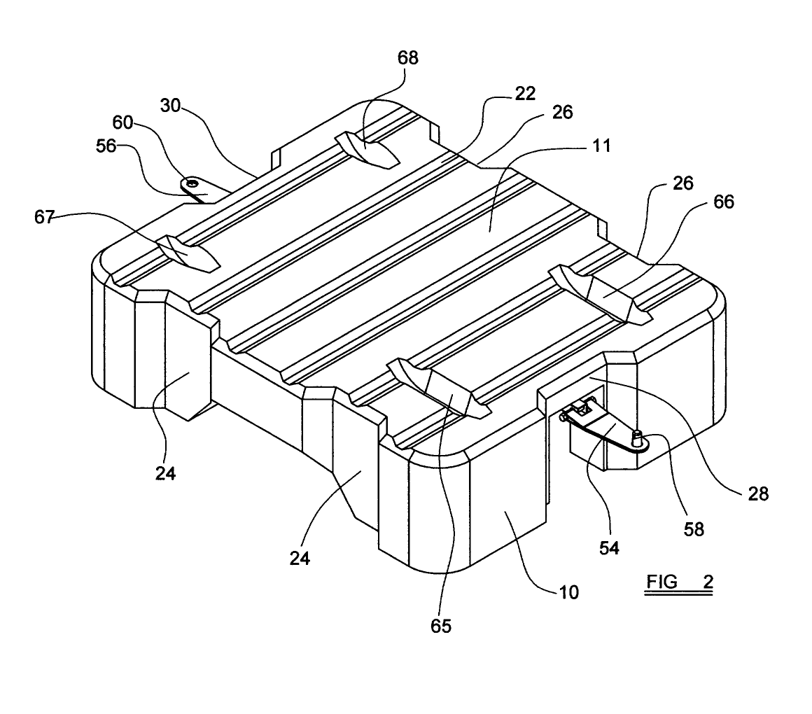

FIG. 2 is a view of the dolly from above and from one corner.

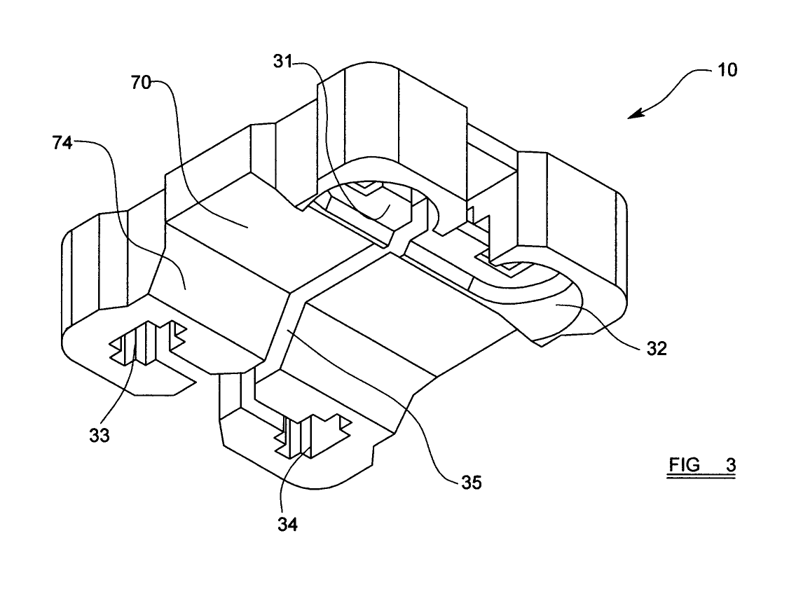

FIG. 3 is a view similar to FIG. 1 of a load-carrying body part of the dolly.

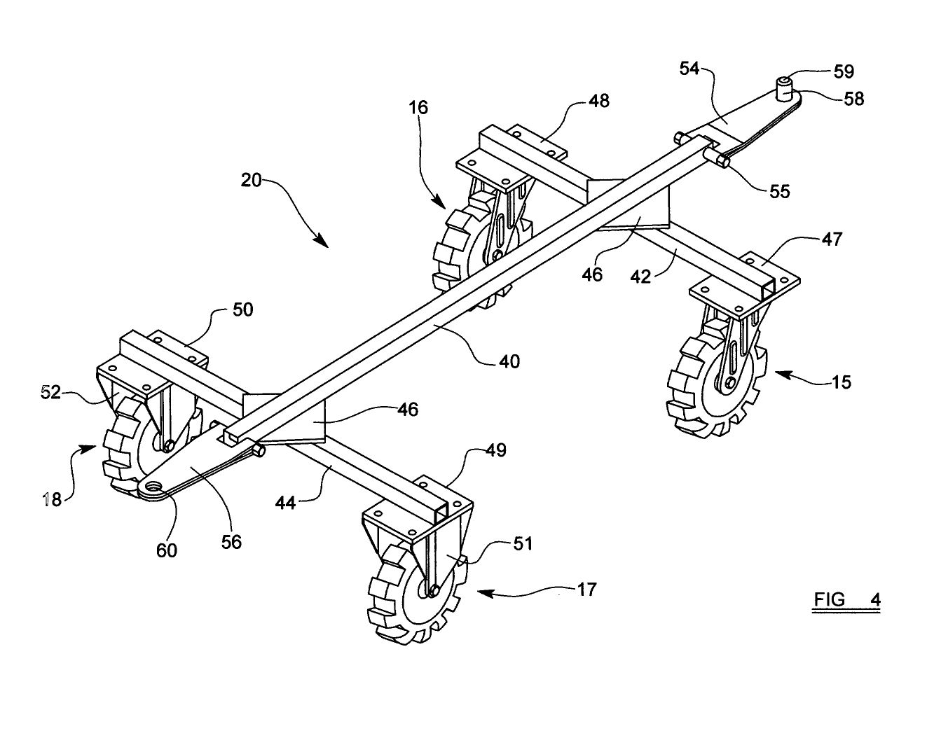

FIG. 4 is a view of a chassis of the dolly.

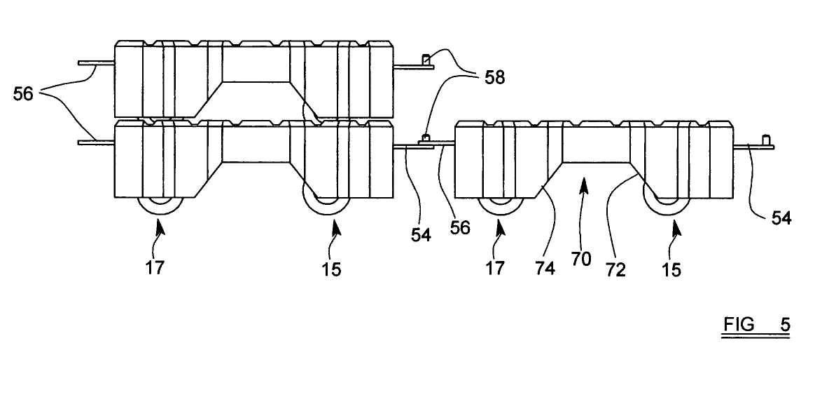

FIG. 5 is a side view showing how dollies as previously described may be coupled to one another and stacked upon one another.

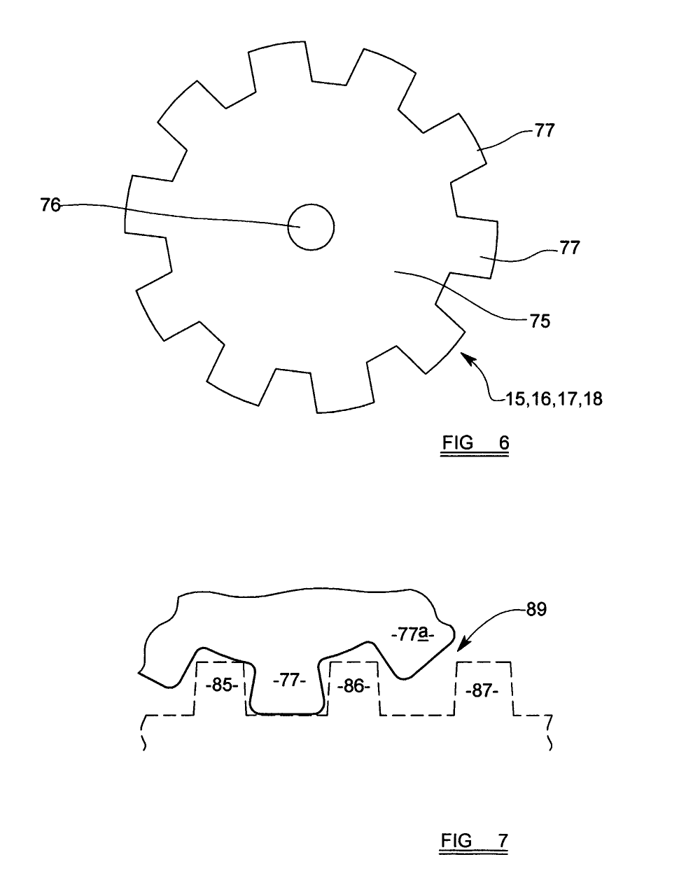

FIG. 6 illustrates the profile of a wheel of the dolly.

FIG. 7 illustrates the interaction between a wheel of the dolly and a corrugated load surface of a wagon.

Referring firstly to FIGS. 1 to 4 of the drawings, a dolly in accordance with the invention comprises a body structure 10 which is in the form of a small platform of generally rectangular shape in plan view, affording an upwardly presented load-carrying surface 11 on which a materials-handling package, e.g. a crate or pallet, may be placed. As seen in FIG. 1, the dolly has four wheels 15, 16, 17, 18, part of the peripheries of which extend beneath the body part 10 to enable the dolly to be moved on the wheels over a supporting surface. The wheels are carried by a chassis assembly 20 illustrated in FIG. 4, which fits to the body part 10 which is shown in greater detail in FIG. 3. The wheels 17, 18 are rotatable about a fixed axis extending transversely of the dolly, while the wheels 15, 16, as well as being rotatable about respective axes, are pivotable in the manner of castor wheels, about vertical or generally vertical axes to facilitate steering of the dolly when it is being moved on its wheels over a supporting surface.

The body part 10 is seen most clearly in FIGS. 2 and 3 of the drawings. It is made of a plastics material of suitable properties, by any appropriate manufacturing technique or techniques, e.g. rotational moulding. For example it may be of a suitable type of polyethylene or polypropylene. It preferably is of one-piece construction, but may incorporate an initially-separate component or components. It may comprise a “skin” or surface layer of material, containing a core of other material e.g. a foamed material. Its load-carrying surface 11 is largely flat, but with a number of transverse grooves or corrugations as indicated at 22, which can assist a materials handling package to remain in position thereon. It may be of any suitable configuration, or be provided with any appropriate retaining formations or the like for this purpose. In plan view its overall shape is rectangular, but its opposite sides are each provided with two inwardly extending recesses 24, 26, and its ends with recesses 28, 30.

The underside of the body part 10, seen most clearly in FIG. 3, has upwardly extending recesses 31, 32, 33, 34, and a longitudinal recess 35, for receiving the wheels 15, 16, 17, 18, respectively and for the chassis parts which support the wheels. The recesses 31, 32 provide sufficient room for the wheels 15, 16, to pivot about their vertical or near vertical pivot axes, whilst the recesses, 33, 34, receive the wheels 17, 18, and their supporting parts as a relatively close fit as there is no need for pivoting these wheels.

Referring now to FIG. 4 of the drawings, the chassis assembly 20 comprises a longitudinal central spine member 40 of box-section metal e.g. steel, adjacent whose ends are provided transverse members 42, 44, being secured to the spine member 40 by welding with the interposition of attachment plates 45, 46. At the free ends of the transverse member 42 there are mounting plates 47, 48, which carry castor assemblies respectively having the wheels 15, 16. The means by which the wheels 15, 16 are able to pivot about their castor axes are not shown. Similarly the transverse member 44 has mounting plates, 49, 50 at its free ends, to which generally U shaped supporting elements 51, 52 for the wheels 17, 18, are fixed.

At the ends of the spine member 40, there are coupling members. At the end adjacent the wheels 15, 16, a coupling member 54 is connected by a bolt or pivot pin 55 extending transversely through the spine member, enabling the coupling member to pivot upwardly or downwardly about an axis extending transversely of the spine member. At the opposite end of the spine member, coupling member 56 is similarly connected to the spine member. Coupling member 54 has an upwardly extending coupling pin 58, while coupling member 56 has an aperture 60 adjacent its free end, dimensioned to receive a coupling pin as 58. Thus, adjacent dollies may be coupled in front of and behind one another, with the coupling pin of one dolly being passed through the aperture 60 in the coupling member 56 of the adjacent dolly, and a retaining clip or the like being passed through a transverse aperture 59 adjacent the top of the coupling pin, so that the pin is held captive within the coupling aperture.

When the coupling members 54, 56 are not being used to couple adjacent dollies to one another, they can pivot and hang downwardly from the ends of the spine member 40, or alternatively, can be pivoted upwardly to lie against the ends of the body part of the dolly. In the latter case, they will clear any obstruction on the surface over which the dolly is being moved. A number of dollies, e.g. eight or a multiple thereof, may be connected to one another to form a “train”, and moved with one another by a towing vehicle. When dollies are not in load carrying use, empty dollies may be stacked one upon the other, and to this end the load-carrying surface 11 of the dolly may be provided with recesses 65, 66, 67, 68 whose positions correspond of the positions to the wheels 15, 16, 17, 18. The positions of the recesses 65, 66 for receiving the lower peripheral parts of the wheels 15, 16, correspond to the straight-ahead pivoting position of the wheels 15, 16, in which they are depicted in FIGS. 1 and 4 of the drawings.

It will be noted that the wheels 15, 16, are spaced relative to one another by a slightly smaller distance than are the wheels 17, 18, i.e. the wheels 15, 16 when straight ahead are closer to the centre of the dolly. Such spacing of the pivotable castor wheels is helpful in manoeuvreability of the dolly, particularly when a train of several dollies is being pulled around a corner.

It will further be noted that the body part 10 of the dolly has in its mid region a large transversely extending recess in its underside. Such recess is clearly visible at 70 in FIG. 3, and in FIG. 5. It will be noted that the recess has inclined front and rear walls 72, 74 which reach the bottom of the body part of the dolly very close to the wheels. If a dolly is being moved between surfaces inclined to one another, such as surmounting the top of a ramp leading up to a level or even downwardly inclined surface, the recess renders grounding of the dolly between its wheels unlikely in most circumstances.

FIG. 5 shows two dollies coupled to one another in train for being moved together, and also shows one empty dolly stacked upon another empty dolly with the wheels of the uppermost such dolly engaging the recesses in the load carrying surface of the lower dolly, as above referred to. Such dollies placed upon one another are unlikely to become accidentally displaced.

FIG. 6 shows, in side view, i.e. viewed in a direction parallel to its axis of rotation, one of the wheels 15, 16, 17, 18. It is a moulding of a suitable material which preferably incorporates elastomeric and polymeric constituents to give it the required strength while imparting some degree of resilience and wear resistance. It has a body 75 with a central aperture 76 by which the wheel is rotatably received on a suitable axle in its pivotable or non-pivotable supporting element. The material of the wheel may be such that it can run on the axle without any intervening bearing bush or assembly, in view of the fact that dollies such as that with which the invention is concerned are generally only moved for short distances and at slow speeds. The periphery of the wheel comprises a plurality of circumferentially spaced projections 77 with recesses therebetween, both of which are generally rectangular in form, although the sides of the projections are not exactly parallel to one another. By way of example only, the radius of the wheel at the peripheral surface of its projections may be about 100 mm, and the radius at the bottoms of the recesses of the order of 78 mm. The projections and recesses have rounded corners, e.g. with a small radius of about 5 mm.

FIG. 7 illustrates how the peripheral surface of a wheel of this configuration runs over a corrugated support surface such as that of the load carrying deck of a railway wagon for car transportation. In FIG. 7, successive corrugations of the deck surface are indicated in broken lines at 85, 86, 87, with troughs therebetween. One of the projections 77 of the wheel is illustrated fully occupying the trough between the ridges 85, 86, of the deck, while an adjacent projection 77a of the wheel is about to enter the trough between the ridges 86, 87, of the deck. It will be noted that the projection 77a on the wheel will, prior to entering the trough between the ridges 86, 87, have some tendency to contact the edge 89 of the ridge 87 and this can give a “self-chocking” effect when a train of the dollies is secured in a wagon by restraining straps or the like connected to the front and rear dollies.

The width of each of the wheels 15, 16, 17, 18, is greater than the width of each of the troughs between the corrugations 85, 86, 87, to be found on the support surface of a railway wagon for car transportation. Thus, the pivotable castor wheels 15, 16, of a dolly are not able, should they pivot to positions at right angle to the straight-ahead position, to become trapped in the troughs of the deck. As well as providing the above described advantages when a dolly is used on such a corrugated surface, the configuration of the wheels with their spaced projections and recesses also assists their surmounting obstacles such as hoses or cables should they be encountered when a dolly is being moved on a factory floor surface for example.

When a materials handling package, e.g. a pallet or crate, is loaded onto a dolly by being placed on the load-carrying surface thereof, it will normally be retained in position by using a retaining device or devices, for example retaining straps which pass over the materials handling package and are connected to appropriate formations provided on the body part of the dolly. Dollies may be loaded individually or when coupled together in a train, and a train of dollies loaded onto vehicle-transportation rail wagons as previously described herein. At the destination, they would be unloaded as hereinbefore described.

Further features which may be provided in a dolly include the provision of a transponder device, or a compartment in which such a device may be placed, to enable the position and movements of the dolly to be tracked by appropriate detecting equipment.

Although as described above the wheels of the dolly are carried by a chassis assembly 20 as shown in FIG. 4, over which the body part 10 as shown in FIG. 3 is fitted and secured thereto, it is possible that with an appropriately-strong construction of the body part 10 the separate chassis assembly could be dispensed with. In this case, individual wheels and coupling members could be secured directly to the body part. It would be possible for a suspension device to be provided for each of the wheels, to enable sprung upwards and downwards movement of the wheels relative to the body part 10. Alternatively or in addition, the wheels could be retractable upwardly relative to the body part 10, to facilitate stacking of the dollies on top of one another when they are not in use. Although, as above described the provision of recesses 65, 66, 67, 68 in the load-carrying surface of the dolly, with which the wheels of a super-positioned dolly can engage, is advantageous.

Possibly a supporting device could be provided which is able to engage with two of the dollies coupled together, and itself afford a load-carrying surface able to carry a load of much greater dimensions, in plan view, than can be carried by a single dolly. Such a supporting device would hold the dollies in alignment relative to one another. By the use of such a device, the versatility of the dolly, in terms of the types of dimensions of loads it can carry, can be greatly increased.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A dolly on which a load can be carried and having wheels enabling its movement over a support surface, wherein the wheels each have a peripheral surface which comprises a plurality of spaced projections and recesses therebetween.

2. A dolly according to claim 1 adapted for running on a corrugated support surface with the projections entering troughs between ridges of the support surface.

3. A dolly according to claim 2 adapted to run on a corrugated support surface in which the corrugations are of generally rectangular form, and wherein the projections on the wheel surface are of somewhat rectangular form, viewed parallel to the rotational axis of the wheel.

4. A dolly according to claim 3 wherein the width of each wheel is greater than the spacing between the ridges of the corrugated support surface.

5. A dolly according to claim 1 wherein the wheels are of a rubber material, polymeric material, or rubber and polymeric material.

6. A dolly according to claim 1, comprising a body part of plastics material, affording a load-carrying surface.

7. A dolly according to claim 6 wherein the wheels are partially accommodated in recesses provided in the body part, so that a portion only of the periphery of each wheel extends outwardly beneath the body part.

8. A dolly according to claim 1 wherein the wheels are rigidly supported in respect of upwards and downwards movement relative to the body part.

9. A dolly according to claim 6 wherein the wheels are carried by a chassis assembly to which the body part is secured.

10. A dolly according to claim 1 comprising two wheels which are pivotable about respective castor axes and two wheels which are not pivotable in such manner.

11. A dolly according to claim 1 comprising coupling means enabling a number of dollies to be connected together and handled as a train of dollies.

12. A dolly according to claim 1 further comprising means for accommodating an identification device such as a radio transponder.

13. A method of transporting goods, comprising loading the goods on at least one dolly according to claim 1, and carrying the dolly on a vehicle.

14. A method according to claim 13 wherein the vehicle is a railway wagon for motor vehicle transportation.

15. A method according to claim 14 comprising coupling a plurality of dollies together to form a train thereof, and loading the train of dollies onto at least one of the wagons.

16. A method according to claim 15 comprising securing the coupled dollies on the or each wagon by engaging end ones of the coupled dollies thereon by retaining devices.

17-18. (canceled)

19. A dolly according to claim 8 wherein the wheels are carried by a chassis assembly to which the body part is secured.
